(19) United States
(12) Patent Application Publication
(10) Pub. No.: US 2021/0104355 A1
(43) Pub. Date: Apr. 8, 2021

(54) CHOKE COIL

(71) Applicant: MODA-INNOCHIPS CO., LTD., Ansan-Si, Gyeonggi-Do (KR)

(72) Inventors: Gyeong Tae KIM, Ansan-Si, Gyeonggi-Do (KR); Sang Hyun KIM, Gwangju-Si, Gyeonggi-Do (KR)

(21) Appl. No.: 16/608,180

(22) PCT Filed: May 10, 2018
(86) PCT No.: PCT/KR2018/005376

§ 371 Date: Oct. 24, 2019

(30) Foreign Application Priority Data
May 12, 2017 (KR) 10-2017-0059289
Sep. 29, 2017 (KR) 10-2017-0127911

(51) Int. Cl. H01F 27/28; H01F 17/04; H01F 27/29

(52) U.S. Cl. CPC H01F 27/2828; H01F 2017/0093; H01F 27/29; H01F 17/04

(57) ABSTRACT

The present disclosure provides a choke coil including a core, a flange provided on each of both end portions of the core in one direction, a terminal electrode coupled to the flange, and a wire wound around the core and having end portions each led out onto the terminal electrodes, wherein the wire is led out onto the terminal electrode on a side surface of the flange.

### TECHNICAL FIELD

The present disclosure relates to a choke coil, and more particularly, to a choke coil capable of assuring stable characteristics by being mounted on a vehicle or the like.

### BACKGROUND ART

In a choke coil according to the related art, terminal electrodes were formed on flanges of a drum core by plating or soldering, a pair of wires were wound around the drum core, and then, ends of the wires were soldered to the terminal electrodes. The terminal electrodes of such choke coils were attached by soldering to a printed wiring board of a vehicle.

When the choke coil according to the related art is mounted on a vehicle, reliability under a wide range of temperatures should be assured. However, defects, such as detachment of the terminal electrode from the printed wiring board or a crack in the drum core, occur.

Thus, recently, a choke coil is manufactured such that “C”-shaped terminal electrodes are inserted into and fastened to flanges, ends of a wire are fixed to portions of terminal electrodes, and then, weld parts are formed on upper portions of the terminal electrodes by using laser welding or arc welding. That is, in the choke coil according to the related art, the terminal electrodes are provided on the upper and lower portions of the flanges. Therefore, first and second wires wound around a core are led out to the upper outside of the core. At this point, the first wire brought into contact with and wound around the core moves from the core to move to an upper portion of a terminal electrode while forming an angle of at least 0° in the diagonal direction. However, since the second wire is wound around the first wire, the phenomenon occurs in that the second wire is positioned over the first wire in the diagonal direction and the second wire presses the first wire. Accordingly, a limitation occurs in that the first wire fixed on to the terminal electrode is pressed by the force of the second wire, whereby the positions of the wires are misaligned.

Meanwhile, in order to assure heat resistance against the difference in thermal expansion between the core and the terminal electrode, the core and the terminal electrode connected to a printed wiring board are spaced apart from each other, and thus, when a strong shock or vibration occurs, the flange may be detached in a direction in which the “C”-shaped terminal electrode is not provided. That is, the flange may be detached from the terminal electrode in the direction exposed by the “C”-shaped terminal electrode. In addition, in case of a vehicular product, since strong vibration or shock frequently occurs, high reliability is being demanded, and when a crack occurs in a fillet portion of the terminal electrode which surrounds the core against horizontal vibrations of the wiring board, a short-circuit is caused and a detrimental defect may be caused.

### PRIOR ART DOCUMENT

Japanese Patent Laid-open Publication No. 2003-022916

### DISCLOSURE

### Technical Problem

The present disclosure provides a choke coil capable of preventing positional misalignment of a first wire due to a second wire.

The present disclosure also provides a choke coil in which a terminal electrode is formed on a side surface of a flange and a wire is led out from the side surface of the flange.

The present disclosure also provides a choke coil capable of preventing a phenomenon in which a terminal electrode is formed on a side surface of a flange, and a first wire is pressed by a second wire during the led-out of the wire.

### Technical Solution

In accordance with an exemplary embodiment, a choke coil includes: a core; a flange provided on each of both end portions of the core in one direction; a terminal electrode coupled to the flange; and a wire wound around the core and having end portions each led out onto the terminal electrode, wherein the wire is led out onto the terminal electrode on a side surface of the flange.

The terminal electrode may include: a first terminal brought into contact with a second surface opposed to a first surface of the flange brought into contact with the core; a second terminal brought into contact with one vertical surface of the flange; and a third terminal brought into contact with a side surface of the flange in the horizontal direction, wherein the wire may be led out while being in contact with the third terminal.

The flange may further include a groove formed in the side surface thereof.

The terminal electrodes may further include a guide groove formed in the third terminal so as to be fastened to the groove of the flange.

The choke coil may further include a guide part provided on the third terminal and configured to guide led-out of the wire.

The guide part may be provided under the flange.

The guide part may have at least a portion protruding toward an outside of the flange.

The choke coil may further include a guide part defined by at least a protruding portion of the flange and configured to guide the wire.

The second terminal may extend from the first terminal, and the third terminal may extend from the second terminal.

The choke coil may further include an opening part formed on the third terminal.

The opening part may be formed in a wider width than the wire and in a shorter length than the wire.

The choke coil may further include a weld part formed in each of end portions of the wire.

The choke coil may further include an insulating layer provided on at least a region between the weld part and the terminal electrode.

### Advantageous Effects

A coke coil in accordance with exemplary embodiments is provided with flanges on both end portions of a core around which a wire is wound, and terminal electrodes are fastened to side surfaces of the flanges. In addition, first and second wires wound around the core are led out onto the terminal electrodes on the side surfaces of the flanges. Accordingly, when the first and second wires are led out, a phenomenon in which the first wire is crushed by the second wire may be prevented, whereby the positional misalignment of the first wire may be prevented.

In addition, guide parts are formed to extend outward from the terminal electrodes on the side surfaces of the flanges, and the wire may be led out along the guide parts. Thus, the wire may be easily led out and positional misalignment of the wire may be prevented.

Meanwhile, since the terminal electrodes are provided to be coupled to the flanges in at least two directions perpendicular to each other, the terminal electrodes may be prevented from being detached by a vibration or the like, and the height of the choke coil may be reduced by forming weld parts on the side surfaces of the flanges.

### BRIEF DESCRIPTION OF THE DRAWINGS

Exemplary embodiments can be understood in more detail from the following description taken in conjunction with the accompanying drawings, in which:

FIGS. 1 and 2 are assembled perspective views and an exploded perspective view of a choke coil in accordance with a first exemplary embodiment;

FIGS. 3 to 6 are a top view, a bottom view, one and the other side views of a choke coil in accordance with the first exemplary embodiment;

FIGS. 7 to 9 are views illustrating modified exemplary embodiments of a terminal electrode of a choke coil in accordance with the first exemplary embodiment;

FIGS. 10 and 11 are an exploded perspective view and an assembled perspective view of a choke coil in accordance with a second exemplary embodiment;

FIGS. 12 to 14 are perspective views illustrating a manufacturing method of a choke coil in accordance with a third exemplary embodiment;

FIGS. 15 and 16 are an upper perspective view and a lower perspective view of a choke coil in accordance with a fourth exemplary embodiment; and

FIGS. 17 to 20 are a top view, a bottom view, one and the other side views of a choke coil in accordance with the fourth exemplary embodiment; and

FIG. 21 is an enlarged view of a choke coil in accordance with a modified example of exemplary embodiment.

### DETAILED DESCRIPTION OF EMBODIMENTS

Hereinafter, exemplary embodiments will be described in detail with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art.

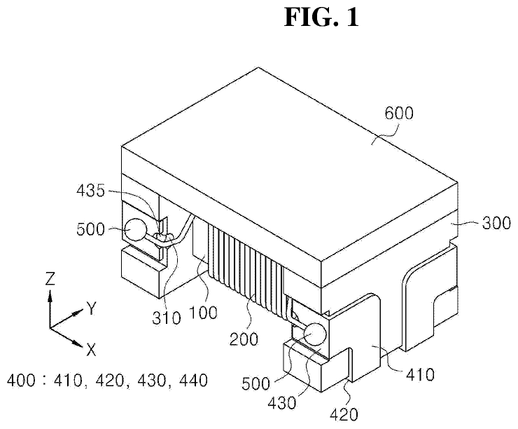

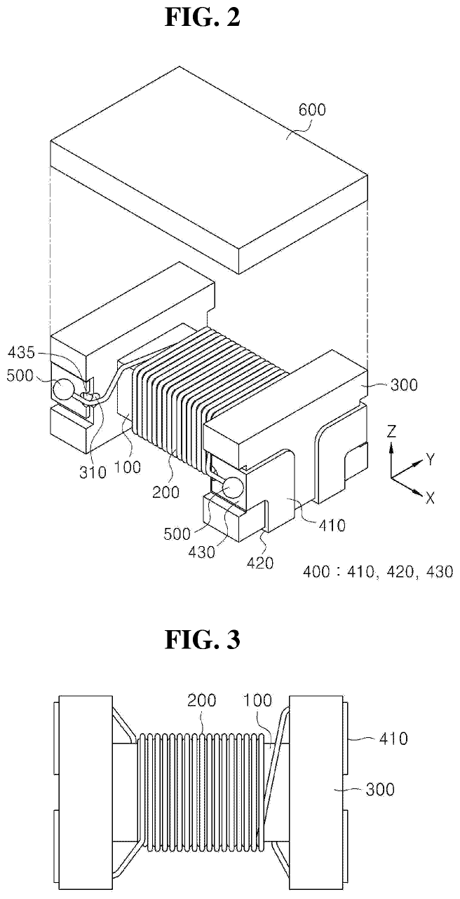

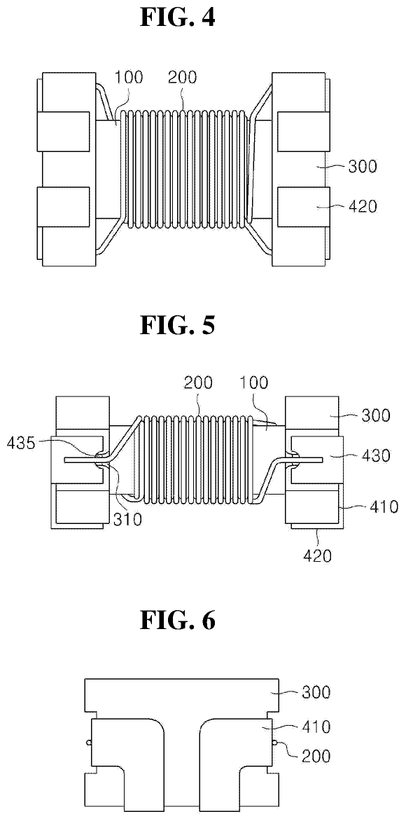

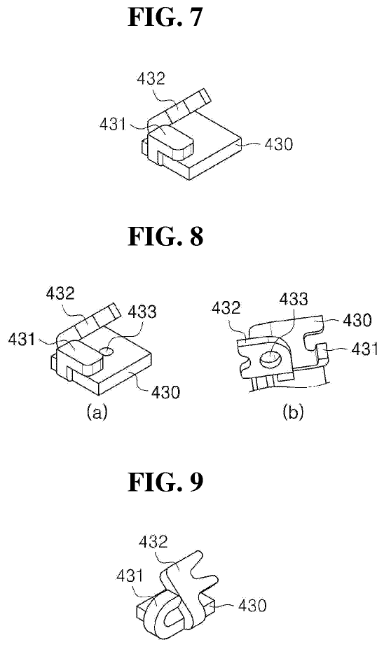

FIG. 1 is an assembled perspective view of a choke coil in accordance with a first embodiment, and FIG. 2 is an exploded perspective view. FIGS. 3 and 6 are a top view, a bottom view, one and the other side views of a choke coil in accordance with the first exemplary embodiment. In addition, FIGS. 7 to 9 are views illustrating modified examples of a terminal electrode of a choke coil in accordance with the first exemplary embodiment.

Referring to FIGS. 1 to 9, a choke coil in accordance with a first exemplary embodiment may include: a core 100; a wire 200 wound around the core 100; flanges 300 provided on both end portions of the core 100; terminal electrodes 400 fastened to both sides of the flanges 300; weld parts 500 formed on the terminal electrodes 400; and a lid part 600 provided over the core 100.

1. Core

The core 100 may be provided in an approximately hexahedral shape, and the wire 200 may be wound to be brought into contact with and surround the core 100. For example, the core 100 has approximately rectangular cross-sectional shapes in the longitudinal direction (X-direction) and the width direction (Y-direction), respectively, and the core 100 may be provided in a larger size in the X-direction than in the Y-direction. At this point, the direction in which the flanges 300 are provided is referred to as the longitudinal direction (the X-direction) and the direction perpendicular to the longitudinal direction is referred to as the width direction (the Y-direction). That is, the core 100 may be provided with: first and second surfaces (that is, front and rear surfaces) opposed to each other in the X-direction; third and fourth surfaces (that is, two side surfaces) opposed to each other in the Y-direction; and fifth and sixth surfaces opposed to each other in a Z-direction (that is, upper and lower surfaces), wherein the distance between the first and second surfaces may be greater than the widths of the third and fourth surfaces. In addition, the core 100 may be formed to have a rounded edge and have a predetermined inclination. That is, the edge portions between the third to sixth surfaces (that is, between the two side surfaces and the upper and lower surfaces) may be formed to be rounded and to have the predetermined inclination. As such, the core 100 is formed to have the rounded edges, whereby the limitations such as disconnection of the wire 200 due to a sharp edge while the wire 200 is wound may be prevented. Of course, the core 100 may also be provided in a circular cylinder shape or in a polyhedral shape. For example, the core 100 may have a polygonal shape of at least a pentagonal shape when viewed in a plan view or a cross-sectional view in the X-direction, and may be provided in a predetermined length in the X-direction. The flanges 300 may be provided on both end portions of the core 100, that is, on the first and second surfaces in the X-direction. Meanwhile, the core 100 may be manufactured by using a ferrite material. As the ferrite material, one or more selected from the group consisting of nickel (Ni) ferrite, copper (Co) ferrite, manganese (Mn) ferrite, cobalt (Co) ferrite, barium (Ba) ferrite, and nickel-zinc-copper (Ni—Zn—Cu) ferrite, and a ferrite of one or more oxides thereof. The core 100 may be manufactured in such a way that such a ferrite material and, for example, a polymer are mixed, and then, the mixture is formed in a predetermined shape such as a hexahedron.

2. Wire

The wire 200 may be provided to surround the core 100. That is, the wire 200 may be provided to surround the core 100 from one side toward the other side in the X-direction, for example, from the first surface toward the second surface. In addition, the wire 200 may be led out such that both end portions thereof are brought into contact with the terminal electrodes 400 fastened to the flanges 300. The wire 200 may be wound onto the core 100 in at least one or more layers. For example, the wire 200 may include: a first wire to be in contact with and wound around the core 100; and a second wire to be in contact with and wound around the first wire. At this point, both ends of the first wire may extend to the terminal electrodes which are fastened to the two flanges 300 and face each other, and both ends of the second wire may extend to the terminal electrodes which are fastened to the two flanges 300 and face each other and to which the first wire does not extend. Meanwhile, the wire 200 may be formed of a conductive material and be coated with an insulating material so as to be surrounded by the insulating material. For example, the wire 200 may be formed such that a metal wire such as a copper wire is formed in a predetermined thickness and an insulating material such as a resin coats the metal wire. For the insulating coating, polyurethane, polyester, polyester imide, polyamide imide, polyimide, or the like may be singly used, or a mixture or a laminate of at least two or more thereof may also be used. For example, for the insulating coating, a mixture of polyester and polyamide may be used, or a laminate thereof may also be used. Meanwhile, the insulating coatings on the end portions of the wire 200 brought into contact with the terminal electrodes 400 may be completely removed and the metal wire may thereby be exposed. In order to completely remove the insulating coating, the coating may be irradiated with laser at least two times. For example, the end portions of the wire 200 is irradiated with first laser, and then the portion irradiated with the first laser is irradiated with second laser, whereby the insulating coating may completely be removed. The insulating coatings on the end portions of the wire 200 are completely removed, whereby the insulating coatings are not present between the terminal electrodes 400 and the wire 200. Of course, in the end portions of the wire 200, only a portion of insulating coatings may be removed, the portion contacting the terminal electrodes 400. That is, the insulating coatings in the region contacting the terminal electrodes 400 may be removed, and the insulating coatings in the remaining regions including the opposite region of the region contacting the terminal electrodes 400 may remain.

3. Flange

The flanges 300 are provided on both end portions of the core 100. That is, the flanges 300 are provided on both end portions of the core 100 in the X-direction. The flanges 300 may be provided in a plate shape which has two surfaces opposed to each other and has a predetermined thickness. That is, the flanges 300 each may have a first surface brought into contact with the core 100 and a second surface opposed to the first surface, and may have a predetermined thickness in the Y-direction. At this point, in the flanges 300, the two surfaces opposed to each other in the Y-direction will be referred to as side surfaces, and the two surfaces opposed to each other in the Z-direction will be referred to as upper and lower surfaces. Thus, the flanges 300 are provided in a plate shape with a predetermined thickness, and each have: first and second surfaces opposed to each other; two side surfaces which are perpendicular to first and second surfaces in the X-direction and face each other in the Y-direction; and lower and upper surfaces which are perpendicular to the first and second surfaces in the Z-direction and face each other. Here, the thicknesses of the flanges 300, that is the thicknesses in the X-direction may be the same as or greater than the widths of surfaces of the terminal electrodes 400 on to which the wire 200 is led out and mounted. That is, the thicknesses of the flanges 300 may be adjusted according to the widths of the terminal electrodes 400 provided to be in contact with the side surfaces of the flanges 300. Meanwhile, the flanges 300 may be provided to be larger than the core 100 in the Y- and Z-directions. That is, the flanges 300 may have the widths larger than the core 100 in the Y-direction and the heights larger than the core 100 in the Z-direction. In addition, the flanges 300 may have regions having widths smaller than those of other regions thereof in the Y-direction. That is, in the flanges 300, the regions onto which the terminal electrodes 400 are fastened, for example, intermediate regions in the Z-direction may have widths smaller than those of the upper and lower regions. At this point, in the flanges 300, the heights of the intermediate regions having smaller widths may be larger than the heights of the upper and lower regions. For example, in each of the flanges 300, when the lower region with a first width, the intermediate region with a second width smaller than the first width, and the upper region with the first width are formed in the Z-direction, the ratio of the heights of the lower, the intermediate, and the upper regions may be 1:2:1. That is, in each flange 300, the two side surfaces, which are opposed to each other in the Y-direction, may form a shape, such as a “laid H” shape, in which the intermediate region is recessed in the up-down direction. Of course, such a ratio of heights may be variously changed, for example, may be changed according to the heights of the terminal electrodes 400 fastened to the flanges 300.

In addition, each flange 300 may have a predetermined inclination in at least a region with which the wire 200 is in contact while being led out. For example, the flanges 300 may have a predetermined inclination in the intermediate region adjacent to the core 100. Of course, as illustrated in FIGS. 1 and 2, each flange 300 may have a recess part 310 in a region which is adjacent to the core 100 in the intermediate region and with which the wire 200 is in contact while being led out. That is, the recess part 310 may be formed in the predetermined region of a surface adjacent to the core 100 and a surface perpendicular thereto in the intermediate region of each flange 300. The recess parts 310 formed as such may function to guide the led-out of the wire 200. That is, the recess parts 310 are provided in the predetermined regions, whereby the wire 200 may be guided by the recess parts 310 and led out onto the terminal electrodes 400. As described above, the regions which are in the flanges 300 and with which the wire 200 is in contact while being led out are rounded or recessed, whereby disconnection, peel-off of coating, and the like of the wire 200 may be prevented. That is, when edges are formed between the two surfaces of the flanges 300 with which the wire 200 is in contact while being led out, the wire 200 may be chopped and the coating of the wire 200 may also be peeled off, or the wire 200 may also be disconnected. However, by rounding the corresponding portions, disconnection or the like of the led out wire 200 may be prevented.

4. Terminal Electrode

The terminal electrodes 400 are inserted into and fastened to the flanges 300, and provided with weld parts 500 formed by fixing the wire 200 in some regions thereof. That is, the weld parts 500 are each formed such that the wire 200 is brought into contact with and fixed onto one surface of each of the terminal electrodes 400 which are provided to be in contact with two side surfaces of each flange 300. The terminal electrodes 400 may be provided in a shape which can be brought into contact with and fastened to a plurality of surfaces of the flanges 300. That is, the terminal electrodes 400 may be provided in shapes brought into at least two surfaces of the flanges 300. For example, as illustrated in FIGS. 1 and 6, the terminal electrodes 400 each may include: a first terminal 410 brought into contact with the second surface of a flange 300; a second terminal 420 brought into contact with the lower surface of the flange 300; and a third terminal 430 brought into contact with a side surface of the flange 300. The first terminal 410 may have an approximately rectangular shape, and have a first side provided at an edge between the second surface and a side surface of the flange 300. In addition, the first terminal 410 includes a portion extending toward the lower surface of the flange 300 with a predetermined width from a second side thereof perpendicular to the first side thereof. At this point, the extension portion may extend up to the edge region between the second surface and the lower surface of the flange 300. Accordingly, the first terminal 410 may be formed in a “I” shape, for example. The second terminal 420 may be formed along the lower surface of the flange 300 perpendicularly from the downwardly extending portion of the terminal 410. At this point, the widths, that is, the widths in the Y-direction of the extension portion of the first terminal 410 and the second terminal 420 may be smaller than the width of the first terminal 410. In addition, the third terminal 430 may be provided along a side surface of the flange 300 from one side of the first terminal 410 corresponding to the edge between the second surface and the side surface of the flange 300. At this point, the third terminal 430 may be provided to be in contact with the recess region provided in the side surface of the flange 300. As described above, the terminal electrodes 400 each may be brought into contact with and fastened to the lower surface and side surfaces from the first surface of the flange 300. Meanwhile, the third terminal 430 may be provided with a recess part 435 on a region facing the core 100, that is, a central part much separated from the first terminal, corresponding to the recess part 310 of the flange 300. The recess part 435 may be provided to guide the led-out of the wire 200. In addition, two terminal electrodes 400 for one flanges 300, and in total, four terminal electrodes may be provided.

Meanwhile, predetermined inclinations are formed between the second surface and the side and lower surfaces of the flanges 300, whereby the second terminal 420 and the third terminal 430 may move along the inclinations to the lower surface and the side surface of the flange 300. In addition, the first terminal 410 and the second and third terminals 420 and 430 may form right angles. However, in order to further enhance the coupling force by a pressing force of any one of the second terminal 420 and the third terminal 430, the first terminal and the second and third terminals 420 and 430 of the terminal electrode 400 may form acute angles less than 90°, such as approximately 88°.

5. Weld Part

The weld parts 500 are formed on the third terminals 430 of the terminal electrodes 400 fastened to the side surfaces of the flanges 300. The weld parts 500 may be formed by laser irradiation in a state in which the wire 200 is mounted on the terminal electrodes 400. That is, the weld parts 500 may be formed by melting the wire 200 on the terminal electrodes 400. In addition, the weld parts 500 may be formed in spherical shapes.

6. Lid Part

The lid part 600 may be provided over the core 100 around which the wire 200 is wound and onto which the terminal electrodes 400 are fastened. The lid part 600 may be provided in a shape of an approximately rectangular plate having a predetermined thickness. At this point, the lower surface of the lid part 600 may be brought into contact with the upper surfaces of the flanges 300.

Meanwhile, in order to fix the wire 200 on the terminal electrodes 400 and facilitate the formation of the weld parts 500, as illustrated in FIGS. 7 to 8, the terminal electrodes 400 may be formed in various shapes.

4.1 Modified Example of Terminal Electrode

As illustrated in FIG. 7, first and second extension parts 431 and 432 for fixing the ends of a wire 200 may be provided in a region of a terminal electrode 400 on which the wire 200 is mounted, that is, on a third terminal 430. The first extension part 431 temporarily fixes an end of the wire 200, and the second extension part 432 fixes the end of the wire 200 and forms a weld part 500 together with the wire 200. That is, a portion of the wire 200 and the second extension part 432 are melted, whereby the weld part 500 may be formed.

The first extension part 431 may be formed on the third terminal 430 on a third side opposed to a first side brought into contact with a first terminal 410 of the terminal electrode 400. The first extension part 431 may be formed in a shape of extending in a predetermined height from the third side of the third terminal 430, and then further extending in one direction. That is, the first extension part 431 may include: a height part formed in a predetermined height from the third terminal 430; and a horizontal part extending in one direction from the end of the height part. Accordingly, the first extension part 431 may be formed in a “F” shape. At this point, since the first extension part 431 is formed, a recess part may not be formed in the terminal electrodes 400. Of course, the recess part 435 may be formed and the first extension part 431 may be formed in the terminal electrodes 400, but in this case, the height part of the first extension part 431 may formed adjacent to the recess part. Since the first extension part 431 is formed as such, the wire 200 may be guide by the height part and the horizontal part of the first extension part 431 and be led out. That is, since the wire 200 may be guided between the height part and the horizontal part of the first extension part 431 having a “F” shape, the detachment of the wire 200 may be prevented. In addition, the first extension part 431 may be bent in the led-out direction of the wire 200, that is, in the opposite direction of a core 100. Thus, the horizontal part of the first extension part 431 is brought into contact with the third terminal 430 in a direction perpendicular to the led-out direction of the wire 200, and the horizontal part temporality guides the wire 200.

The second extension part 432 may be provided to be spaced apart from the first extension part 431. For example, the second extension part 432 may be formed on the third terminal 430 on the third side perpendicular to the second side on which the first extension part 431 has been formed. The second extension part 432 may include: a height part provided in a predetermined height over a predetermined region of the third side of the third terminal 430; and a horizontal part formed in a predetermined size from the end of the height part. At this point, the horizontal part may be formed wider than the width of the height part. That is, the horizontal part of the second extension part 432 may be formed larger than the size of the first extension part 431 considering the size of the weld parts 500 and the like. For example, the horizontal part of the second extension part 432 may be formed so as to be widened from the height part in the direction of the first side. In addition, the second extension part 432 may be bent in a direction perpendicular to the bending direction of the first extension part 431. That is, the height part of the first extension part 431 is bent from the second side in the direction of the first side of the third terminal 430, and the second extension part 432 may be bent from the third side in the direction of a fourth side opposed to the third side of the third terminal 430. Accordingly, the horizontal part of the first extension part 431 and the horizontal part of the second extension part 432 fix the wire 200 in the same direction. As such, the wire 200 may be brought into contact with and fixed onto the third terminal 430 of the terminal electrode 400 by means of the first and second extension parts 431 and 432.

Meanwhile, as illustrated in (a) of FIG. 8, an opening 433 may be formed in a third terminal 430 of a terminal electrode 400. The opening part 433 may be formed in predetermined depth and length, and a wire 200 may be positioned over the opening part 433. That is, a side surface of a flange 300 may be exposed under the wire 200 by the formation of the opening part 433. Here, the opening part 433 may be formed in a wider width than the wire 200 and in a shorter length than the wire 200 mounted on the third terminal 430. Thus, the wire 200 may be floated over the opening parts 433 and the endmost portion of the wire 200 may be brought into contact with the third terminal 430. That is, the wire 200 may be brought into contact by a predetermined width from the endmost portion of the wire 200, and a portion of the wire 200 may be floated above the opening parts 433. Of course, a portion of the wire 200 may be brought into contact with the flange 300 through the opening part 433. As such, the wire 200 and a second extension part 432 are positioned on the opening parts 433 and the wire and the second extension part are melted by being irradiated with laser, whereby a weld part 500 may be formed. That is, the weld part 500 may be positioned over the opening parts 433. As such, by the formation of the opening part 433 in the third terminal 430 of the terminal electrode 400, the transfer of energy due to laser irradiation for forming the welding part 500 to the third terminal 430 of the terminal electrode 400 through the wire 200 may be suppressed. Thus, the shape deformation of the third terminal 430 of the terminal electrodes 400 due to the heat during laser irradiation may be prevented, and the weld part 500 may be formed by using optimal energy. In addition, thermal energy transferred to the wound wire 200 is decreased, whereby short-circuit may be prevented. In addition, an air layer is formed between the weld part 500 and the flange 300 by the opening part 433, so that a quick cooling effect may be expected after forming the weld part 500, and the shape of the weld parts 500 may thereby be stably maintained.

In addition, a portion of the weld part 500, formed while the wire 200 and the second extension part 432 of the terminal electrode 400 are welded, is positioned over the opening parts 433 of the terminal electrode 400, whereby the height of the weld part 500 may be lowered. Thus, the area of a height space of the weld part 500 in the Z-direction may maximally be used, whereby product miniaturization and a low-profile design become possible.

Meanwhile, as illustrated in (b) of FIG. 8, an opening part 433 may be formed in a second extension part 432. By the formation of the opening part 433 in the second extension part 432, a space in the height direction of a weld part 500, that is, the space in the Z-direction, may be maximally used, whereby product miniaturization and a low-profile design become possible.

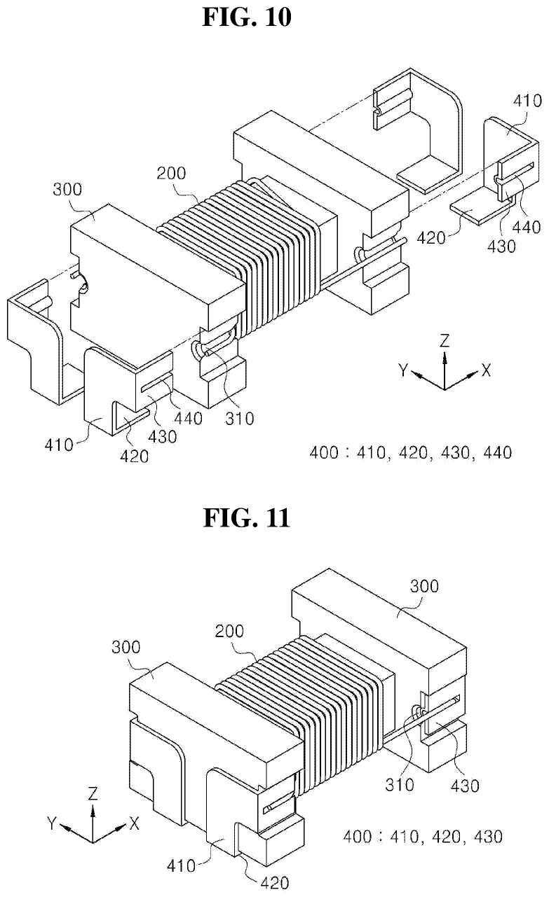

In addition, as illustrated in FIG. 9, the end of a horizontal part of a second extension part 432 may be formed in a “U” shape, and a height part and a horizontal part may be formed in an approximate “F” shape. That is, the horizontal part may be formed in an approximate “U” shape in the direction opposed to a core 100 so that a groove is formed in a region through which a wire 200 passes and a protrusion part is formed on both sides of the groove. At this point, the protrusion parts on both sides may extend to the outside of a terminal electrode 400. That is, the portion protruding in the “U” shape extends up to a region exceeding a first terminal 410 of the terminal electrode 400 assuming the case in which the first terminal 410 of the terminal electrode 400 vertically extends. The second extension part 432 is bent in the direction of a fourth side from a third side of a third terminal 430. Accordingly, in the second extension part 432, the wire 200 passes through the groove part in the “U”-shaped portion, and the protrusion parts on both sides thereof extend to pass through the first terminal 410. As such, the wire 200 may be brought into contact with and fixed onto the terminal electrode 400 by means of the second extension part 432. In addition, since the protrusion parts of the second extension part 432 protrudes to the outside of the first terminal of the terminal electrodes 400, the protruding portions of the terminal electrodes 400 and the wire 200 may be joined by laser welding, and the wire 200 over the terminal electrodes 400 is not peeled off, whereby excessive welding may be prevented.

As described above, in a choke coil in accordance with the first exemplary embodiment, flanges 300 are provided on both end portions of the core 100 around which the wire 200 is wound, and the terminal electrodes 400 are fastened to at least side surfaces of the flanges 300. In addition, an inclined surface (or rounded surface) is formed on an edge portion of each of the flanges 300, on which the terminal electrode 400 is fastened, and facilitates the fastening of the terminal electrode 400, whereby the disconnection of the wire 200 led out to the third terminal 430 of the terminal electrode 400 may be prevented. As such, since the terminal electrodes 400 are provided on side surfaces of the flanges 300, and the wire 200 is led out to the side surfaces of the flanges 300, the phenomenon of crush of a first wire by a second wire may be prevented, and thus, the positional misalignment of the first wire may be prevented.

In addition, by the formation of opening parts 433 in the third terminals 430 on which the wire 200 is mounted, the transfer of energy due to laser irradiation for forming the welding part 500 to the third terminals 430 of the terminal electrodes 400 through the wire 200 may be suppressed. Thus, the shape deformation of the terminal electrodes 400 due to the heat generated during laser irradiation may be prevented, weld parts 500 may be formed by using optimal energy, and the thermal energy transferred to the wound wire 200 may be decreased, whereby short-circuit may be prevented.

A method for manufacturing a choke coil in accordance with an exemplary embodiment will be described as follows.

Firstly, a core 100, both ends of which are respectively coupled to flanges 300, and a lid part 600 are manufactured. The core 100 has approximately rectangular cross-sectional shapes in the longitudinal direction (X-direction) and the width direction (Y-direction), respectively, and the core 100 may be provided in an approximately hexagonal shape with a larger size in the X-direction than in the Y-direction. In addition, the core 100 may be formed to have a rounded edge and have a predetermined inclination. The flanges 300 may be provided on both end portions of the core 100 in the X-direction, be integrally manufacture with the core 100, and also be separately manufactured and coupled to the core 100. At this point, the flanges 300 may be provided so as to have predetermined curvatures in side surfaces in the height direction, that is, in the Z-direction. That is, the flanges 300 may be provided such that a central portion thereof has a smaller width in the height direction than upper and lower portions thereof. In addition, in each of the flanges 300, a recess part may be formed in a predetermined portion of the central portion, and the edges between a first surface which face the core 100 and side surfaces may be roundly formed. Meanwhile, a lid part 600 may be provided in a shape of an approximately rectangular plate having a predetermined thickness.

Subsequently, terminal electrodes 400 are inserted so as to be brought into contact with the side surfaces and the lower surface of the flanges 300 and are coupled to the flanges 300. To this end, the terminal electrodes 400 each may be provided so as to include: a first terminal 410 brought into contact with the second surface of a flange 300; a second terminal 420 extending from the first thermal 410 and brought into contact with the lower surface of the flange 300; and a third terminal 430 extending from the first terminal 410 and brought into contact with a side surface of the flange 300. At this point, edge portions between the second surface, and the lower and side surfaces of the flange 300 are roundly formed, and the terminal electrode 400 may move to the side surface and the lower surface of the flange 300 along the rounded portions.

Subsequently, the wire 200 is wound to surround the core 100. That is, the wire 200 may surround the core 100 from one side to the other side in the X-direction. The wire 200 may include: a first wire to be in contact with and wound around the core 100; and a second wire to be in contact with and wound around the first wire. Both ends of the first wire may extend to the third terminals 430 of the terminal electrodes 400 fastened to the two flanges 300 opposed to each other, and both ends of the second wire may extend to the third terminals 430 of the terminal electrodes 400 respectively fastened to the two flanges 300 which face each other and to which the first wire does not extend. At this point, when the first and second wires are led out, the phenomenon in which the first wire is crushed by the second wire may be prevented, and thus, the positional misalignment of the first wire may be prevented. Meanwhile, the wire 200 may be formed of a conductive material and be coated with an insulating material so as to be surrounded by the insulating material. For example, the wire 200 may be formed such that a metal wire such as a copper wire is formed in a predetermined thickness and an insulating material such as a resin coats the metal wire. After the wire 200 is wound, the coating on the end portions of the wire 200 may be peeled off. The end portions of the wire 200 are peeled off so that all the coatings surrounding the metal wire are removed. To this end, a laser is provided over the wire 200, the upper portion of the wire 200 is then irradiated with the laser, and then, the wire 200 is rotated so that a region which is not irradiated with the laser faces upward, and then the wire 200 may be irradiated again with laser.

Meanwhile, an insulating material is not removed from regions in which the wire 200 is brought into contact with the terminal electrodes 400, and the insulating material in end regions out of the terminal electrodes 400 is removed. That is, end portions of the wire 200 positioned out of the terminal electrodes 400 before forming the weld parts 500 are irradiated with laser at least once, and at least a portion of the coating may be removed. That is, the end portions of the wire 200 positioned out of the terminal electrodes 400 are irradiated with laser from over such that the coating of the upper side may thereby be removed and the coating of the lower side may remain. Alternatively, the coatings of the end portions of the wire 200 may completely be removed by being irradiated with laser from the upper side and lower side respectively. Of course, laser may also be emitted from under such that the coatings on the lower portion of the end portions of the wire 200 are removed and the upper side coatings remain. Consequently, the insulating coatings may be at least partially removed by a laser irradiation method from the end portions out of the terminal electrodes 400 in the direction in which the wire 200 is led out. As such, the insulating coating is not removed from the wire 200 positioned on the terminal electrodes 400, and the insulating coating of the end portions of the wire 200 is partially removed, whereby when the weld parts 500 are formed, insulating layers are present between the wire 200 and the terminal electrodes 400 due to the insulating coating of the wire 200. In addition, insulating layers may remain in at least a region of the weld parts 500 and also in the remaining regions. That is, the wire 200 and the terminal electrodes 400 are present under the weld parts 500, and the insulating layers may remain between the weld parts 500 and the wire 200 and between the wire 200 and the terminal electrodes 400. In addition, the insulating layers may remain also on the surfaces of the weld parts 500 or the like. Consequently, the insulating layers may be present in a plurality of regions around the weld parts 500. This is because the weld parts 500 are formed in a state in which the insulating coating of the wire 200 is not removed between the weld parts 500 and the terminal electrodes 400, and the insulating coating of the wire 200 is removed in a region out of the terminal electrodes 400.

Subsequently, ends of the wire 200, that is, end portions of the wire 200 from which the coating is peeled off are led out to the third terminals of the terminal electrodes 400. At this point, recess parts or inclined surfaces may be formed between the first surfaces and the side surfaces of the flanges 300, and the wire 200 may be led out along the recess parts or the inclined surfaces. In addition, first extension parts 431 each configured from a height part and a horizontal part and having an approximate “F” shape may be formed on the third terminal 430 of the terminal electrode 400. Therefore, the wire 200 is guided between the height part and the horizontal part and is positioned on the third terminal 430 of the terminal electrode 400. At this point, opening parts 433 are formed in the third terminals 430 of the terminal electrodes 400, and the wire 200 may also be mounted over the opening 433. Thus, portions of the wire 200 are positioned on the opening parts 433. Meanwhile, opening parts 433 are formed in the third terminals 430 of the terminal electrodes 400, the wire 200 is led out to pass through over the opening 433. As such, after the wire 200 is mounted, the first extension parts 431 are bent and temporarily fix the wire 200. Subsequently, the second extension parts 432 are bent and fix the wire 200.

Subsequently, the second extension parts 432 are irradiated with laser, whereby the weld parts 500 are formed. That is, the second extension parts 432 and the wire 200 are melted by being irradiated with laser, and thus, the spherical weld parts 500 are formed on the terminal electrodes 400. Here, when the opening parts are formed in the terminal electrodes 400, the weld parts 500 may be formed over the opening parts. The opening parts are formed in the terminal electrodes 400, whereby energy due to the laser irradiation for forming the weld parts 500 may be prevented from being transferred to the terminal electrodes 400 through the wire 200. Thus, the shape deformation of the terminal electrodes 400 due to the heat during laser irradiation may be prevented, and the weld parts 500 may be formed by using optimal energy. In addition, thermal energy transferred to the wound wire 200 is decreased, whereby short-circuit may be prevented. In addition, an air layer is formed between the weld parts 500 and the flanges 300 by the opening parts 433, so that a quick cooling effect may be expected after the formation of the weld parts 500, and the shape of the weld parts 500 may be stably maintained.

Subsequently, a lid part 600 covers the upper portions of the flanges 300 so as to be in contact with the upper part of the flanges 300.

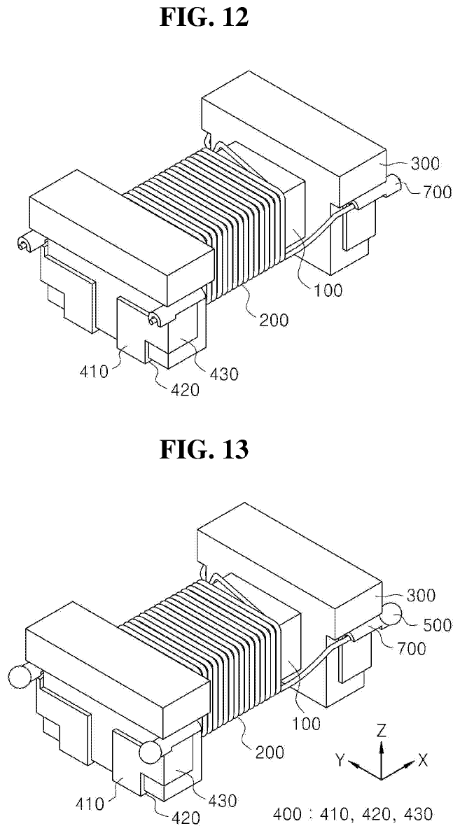

FIGS. 10 and 11 are an exploded perspective view and an assembled perspective view of a choke coil in accordance with a second exemplary embodiment.

Referring to FIGS. 10 and 11, a choke coil in accordance with a second exemplary embodiment may have: grooves 310 on side surfaces of the flanges 300, and wire accommodation parts 440 formed corresponding to the grooves 310 in terminal electrodes 400 fastened to the flanges 300. That is, compared to the first exemplary embodiment, the second exemplary embodiment may further be provided with: the grooves 310 formed in the side surfaces of the flanges 300; and the wire accommodation parts 440 formed in terminal electrodes 400 corresponding to the grooves 310. The terminal electrodes 400 each include: a first terminal 410 brought into contact with the front surface of a flange 300; a second terminal 420 brought into contact with the lower surface of the flange 300; and a third terminal 430 brought into contact with the side surface of the flange 300, wherein wire accommodation parts 440 are each formed in the third terminal corresponding to the groove 310 of the flange 300. Here, when the terminal electrodes 400 are fastened to the flanges 300, the wire accommodation parts 440 are inserted into the grooves 310 of the flanges 300, and the wire accommodation parts 440 may be formed to be further recessed than the surfaces of the third terminals 430. Accordingly, the wire 200 may be accommodated in and led out from the wire accommodation parts 440. Here, the wire accommodation parts 440 may have depths and widths of 1 times to 4 times the diameter of the wire 200 so that at least a portion of the wire 200 may be accommodated therein, and preferably, have depths and widths of 1 times to 2 times the diameter of the wire 200. As such, the grooves 310 are formed in the side surfaces of the flanges 300, and the wire accommodation parts 440 are formed in the terminal electrodes 400 so as to be fastened to the grooves 310. Therefore, the terminal electrodes 400 may further be firmly fastened to the flanges 300. That is, besides the first to third terminals 410, 420 and 430 of the terminal electrodes 400, the wire accommodation parts 440 are further provided. Thus, the contact areas between the terminal electrodes 400 and the flanges 300 are further increased, whereby the fastening of the flanges 300 and the terminal electrodes 400 may be further reinforced. In addition, the wire 200 may further easily be led out through the wire accommodation parts 440 of the terminal electrodes 400.

FIGS. 12 to 14 are perspective views illustrating a manufacturing process of a choke coil in accordance with a third exemplary embodiment. That is, FIG. 12 is a perspective view illustrating a state in which a wire 200 led out from a core 100 to a terminal electrode 400 provided on a side surface of a flange 300, FIG. 13 is a perspective view illustrating a state in which a weld part 500 is formed by joining a terminal electrode 400 and a wire 200, and FIG. 14 is a perspective view illustrating a state in which a lid part 600 is formed. Such a second exemplary embodiment will be described as follows centering on the different contents while omitting the contents overlapping the description of the first exemplary embodiment.

As illustrated in FIGS. 12 to 14, a flange 300 is formed to have, in a Z-direction, that is, in the vertical direction, a wider width in the upper side than in a lower side. That is, the flange 300 may be formed such that a predetermined thickness in the upper side in the vertical direction is formed to be greater in a Y-direction, that is, in the width direction than that in the lower side in the vertical direction. For example, a first region which occupies approximately upper ⅓ of the thickness of the flange 300 may be formed to have wider width than a second region which occupies approximately lower ⅔ of the thickness of the flange 300. For example, the flange 300 may be provided in a “T” shape. A terminal electrode 400 may be provided in the second region having a smaller width in the flange (300). In addition, a guide part 700 which guides the led out of a wire 200 may be formed on an upper side of a third terminal 430 brought into contact with a side surface of the flange 300 of the terminal electrode 400. The guide part 700 may be formed in a predetermined region of the third terminal 430 of the terminal electrode 400, for example, in a boundary region between the first region and the second region of the flange 300. In addition, the guide part 700 may be formed in a shape which is open downward and closed upward. That is, the guide part 700 may be provided in an approximately semi-circle shape which is open in the led-out direction of the wire 200 and is closed in the direction opposite the led-out direction. As such, the guide part 700 is provided in the shape open downward, whereby the guide part 700 may guide the wire 200 led out upward. In addition, the guide part 700 may have a length equal to, or longer or shorter than the length of a third terminal 430 of the terminal electrode 400 in the X-direction. However, to form a weld part 500, it is preferable that the guide part 700 have the same length as the third terminal 430 of the terminal electrode 400. Meanwhile, the weld part 500 may be formed by the fusion of the guide part 700 and the wire 200.

Although not shown, the third exemplary embodiment may further include a portion of the second exemplary embodiment. That is, a groove 310 is formed in the flange 300, and a guide groove 440 is formed in the third terminal 430, whereby the guide groove 440 may be fastened to the groove 310. In addition, the guide part 700 is provided over the guide groove 440, whereby the led-out of the wire 200 may be guided through the guide groove 440 and the guide part 700 and the wire 200 may be accommodated. That is, the guide groove 440 and the guide part 700 may function to accommodate the wire 200 aside from the function of guiding the led-out of the wire 200.

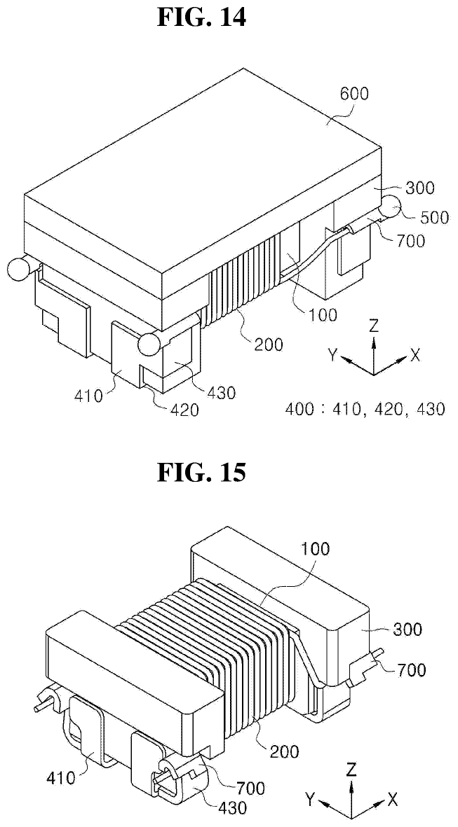

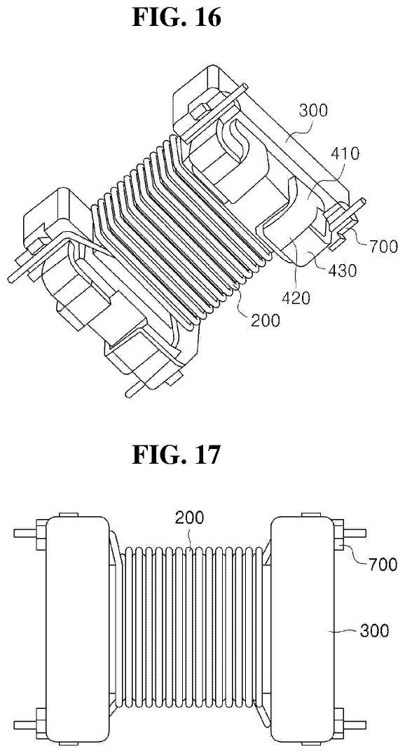

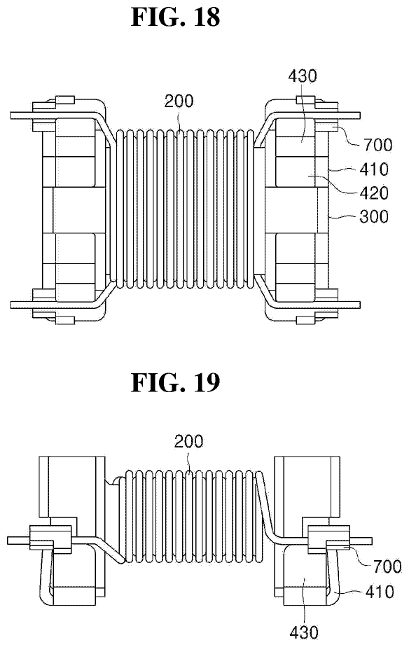

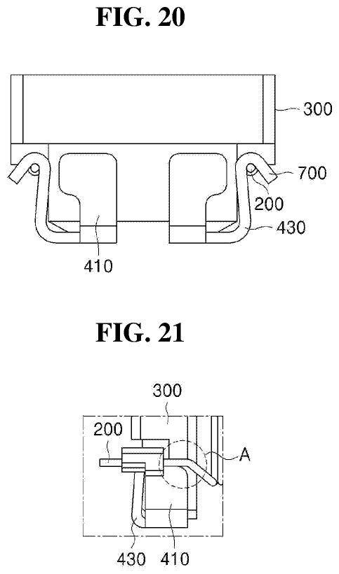

FIGS. 15 and 16 are perspective views illustrating upper and lower sides of a choke coil in accordance with a fourth exemplary embodiment, and FIGS. 17 to 20 are a top view, a bottom view, one side view, and the other side view of a choke coil in accordance with the fourth exemplary embodiment.

Referring to FIGS. 15 to 20, a choke coil in accordance with the fourth exemplary embodiment may include: a core 100; a wire 200 wound around the core 100; flanges 300 provided on both end portions of the core 100; terminal electrodes 400 fastened to both sides of the flanges 300; and guide parts 700 provided in some regions of the terminal electrodes 400. In addition, although not shown, weld parts formed on the terminal electrodes 400; and a lid part provided to cover the upper side of the flanges 300 may further be optionally provided. That is, the choke coil of the exemplary embodiment may not be provided with the weld parts and the lid part, or may be provided with at least one among the weld parts and the lid part. Such a fourth exemplary embodiment will be described as follows centering on the different contents while omitting the contents overlapping the description of the first and second exemplary embodiments.

The flanges 300 may be provided in approximate “T” shapes. For example, in the Z-direction, in each of the flanges 300, the portion 300 from the bottom surface to a first height may have a first width, and the portion from the first height to the top surface may have a second width greater than the first width. That is, each flange 300 may include: a first region having the first width; and a second region provided on the first region and having the second width. At this point, in the first region having the smaller width, at least a portion of each of the terminal electrodes 400 may be fixed in the Y-direction. In addition, in each flange 300, at least one region may have a step in the direction from a first surface brought into contact with the core 100 to a second surface opposed to the first surface, that is, in the X-direction. For example, each flange 300 may have at least one step having a height difference in a lower portion of the second region. That is, each flange 300 may be formed on a step-like shape in which the upper surface of the second region is flat and the lower surface of the second region has at least one step from the first surface to the second surface. At this point, the height of the step may be decreased in the direction from the first surface toward the second surface. For example, two or three steps may be formed. Since at least a portion of each flange 300 is formed in a step-like shape, the terminal electrodes 400 and the guide parts 700 may be accommodated. That is, when two steps are formed, the first step adjacent to the core may be in contact with the third terminal 430 of each terminal electrode 400, and the second step under the first terminal may be in contact with each of the guide parts 700. In addition, when three steps are formed, the first and second steps may be in contact with the third terminal 430 of the terminal electrode 400 and each guide part 700, and the third step lower than the second step may be in contact with first terminal of each terminal electrode 400. At this point, a predetermined thickness of the third step is removed according to the shape of the first terminal 410 of each terminal electrode 400, whereby the entirety of the first terminal 410 may be accommodated in the third step. However, the first region of each flange 300 may be provided with the first and second steps and may not be provided with the third step, or may also be provided with all the first to third steps.

Each terminal electrode 400 may include: a first terminal 410 brought into contact with the second surface of each flange 300; a second terminal 420 brought into contact with the lower surface of the flange 300; and a third terminal 430 brought into contact with a side surface of each flange 300 from the lower surface of the flange 300. At this point, the third terminal 430 may be formed to extend from the second terminal 420. That is, in the first and second exemplary embodiment, the third terminal 430 of each terminal electrode 400 brought into contact with the side surface of each flange 300 is formed to extend from the first terminal 410 of the terminal electrode. However, in the third exemplary embodiment, the third terminal 430 of the terminal electrode 400 brought into contact with the side surface of the flange 300 is formed to extend from the second terminal 420 brought into contact with the lower surface of the flange 300. The first terminal 410 may be formed in an approximate “F” shape and be brought into contact with the second surface of the flange 300. At this point, on the second surface of the flange 300, the third step is formed, and the first terminal 410 may be accommodated in the third step. In addition, the first terminal 410 may have at least one region having a different width. For example, the width of a vertical portion which is connected to the second terminal 420 and is vertically formed may be wider than the width of a horizontal portion horizontally formed from the upper side of the vertical portion. In addition, the vertical and horizontal portion may form a right angle on an outer side and form a dull angel in an inner side. The second terminal 420 may be bent from a lower end of the first terminal 410 and be brought into contact with the lower surface of the flange 300. That is, the second terminal 420 may extend horizontally from the vertical portion of the first terminal 410 and be brought into connect with the lower surface of the flange 300. At this point, the width of the second terminal 420 may be the same as the width of the vertical portion of the first terminal 410. The third terminal 430 may be formed to extend from the side surface of the second terminal 420. At this point, a portion of the third terminal 430 may be brought into contact with the lower surface of the flange 300, and a portion of the third terminal 430 may be brought into contact with a side surface of the flange 300. That is, the third terminal 430 extends from the side surface of the second terminal 420 to an edge of the flange 300 in the Y-direction, and then, upwardly extends in the vertical direction, that is, in the Z-direction and may be brought into contact with a side surface of the flange 300. At this point, the third terminal 430 may be formed such that the width of the region brought into contact with the side surface of the flange 300 is wider than the width of the region brought into contact with the lower surface of the flange 300. In addition, the third terminal 430 may be provided to be in contact with the lower side of the first terminal of the flange 300.

Each of the guide parts 700 may be formed to extend outward in the X-direction from the third terminal 430 of the terminal electrode 400. That is, each guide part 700 may extend in the direction opposite the core 100 and be exposed to the outside of the flange 300. At this point, the guide part 700 may be brought into contact with the second step of the flange 300 and extend from the third terminal 430 of the terminal electrode 400 so as to be exposed to the outside of the flange 300. That is, the guide part 700 may be provided to be higher than the third terminal 430 of the terminal electrode 400. The guide part 700 may be formed in a shape which is open downward and closed upward. That is, the guide part 700 may be provided in an approximate semi-circle shape which is open in the direction toward the led-out wire 200 and is closed in the direction opposite the led-out wire 200. As such, the guide part 700 is provided in the shape open downward, whereby the guide part 700 may guide the wire 200 led out upward. In addition, in the guide part 700, at least a portion may be in contact with the flange 300, and at least a portion may protrude to the outside of the flange 300. For example, one half of the length of the guide part 700 is in contact with the flange 300, and the remaining half may protrude to the outside of the flange 300. Meanwhile, weld parts (not shown) may be formed outside the guide parts formed as such. That is, the ends of the guide parts 700 exposed to the outside of the flanges 300 are irradiated with a laser, whereby the weld parts may also be formed.

Although not shown, the fourth exemplary embodiment may further include a portion of the second exemplary embodiment. That is, a groove 310 is formed in each flange 300, and a guide groove 440 is formed in the third terminal 430, whereby the guide groove 440 may be fastened to the groove 310. In addition, the guide part 700 may be provided over the guide groove 440, whereby the led-out of the wire 200 may be guided through the guide groove 440 and the guide parts 700, and the wire 200 may be accommodated. That is, the guide groove 440 and the guide part 700 may function to accommodate the wire 200 aside from the function of guiding the led-out of the wire 200. In addition, as illustrated in FIG. 21, predetermined gaps may be provided between the lower surface of a first region of each flange 300 and a first terminal 410 of a terminal electrode 400, and the gap functions as an auxiliary guide part A, whereby the led-out of a wire 200 may be guided through the auxiliary guide part A. That is, the led-out of the wire 200 is guided between the flange 300 and the first terminal 410 whereby the wire 200 is allowed to be accommodated in the guide part 700. In addition, at least a portion of the first region of the flange 300 protrudes in the Y-direction, and the protruding portions may also function as the auxiliary guide part A. Of course, the portion, in which at least a portion of the first region of the flange 300 protrudes in the Y-direction, may also function as a guide part, without the formation of a separate guide part 70 in the third terminal 430.

A coke coil in accordance with exemplary embodiments is provided with flanges on both end portions of a core around which a wire is wound, and terminal electrodes are fastened to side surfaces of the flanges. In addition, first and second wires wound around the core are led out onto the terminal electrodes on the side surfaces of the flanges. Accordingly, when the first and second wires are led out, a phenomenon in which the first wire is crushed by the second wire may be prevented, whereby the positional misalignment of the first wire may be prevented.

In addition, guide parts are formed to extend outward from the terminal electrodes on the side surfaces of the flanges, and the wire may be led out along the guide parts. Thus, the wire may be easily led out and positional misalignment of the wire may be prevented.

Meanwhile, since the terminal electrodes are provided to be coupled to the flanges in at least two directions perpendicular to each other, the terminal electrodes may be prevented from being detached by a vibration or the like, and the height of the choke coil may be reduced by forming weld parts on the side surfaces of the flanges.

Meanwhile, the technical idea of the present invention has been specifically described with respect to the above embodiments, but it should be noted that the foregoing embodiments are provided only for illustration while not limiting the present disclosure. In addition, various embodiments may be provided to allow those skilled in the art to understand the scope of the preset invention.

1. A choke coil comprising:
a core;
a flange provided on each of both end portions of the core in one direction;
a terminal electrode coupled to the flange; and
a wire wound around the core and having end portions each led out onto the terminal electrode, wherein
the wire is led out onto the terminal electrode on a side surface of the flange.

2. The choke coil of claim 1, wherein the terminal electrode comprises: a first terminal brought into contact with a second surface opposed to a first surface of the flange brought into contact with the core; a second terminal brought into contact with one vertical surface of the flange; and a third terminal brought into contact with a side surface of the flange in the horizontal direction, wherein the wire is led out while being in contact with the third terminal.

3. The choke coil of claim 2, wherein the flange further comprises a groove formed in the side surface thereof.

4. The choke coil of claim 3, wherein the terminal electrode further comprises a guide groove formed in the third terminal so as to be fastened to the groove of the flange.

5. The choke coil of claim 2, further comprising a guide part provided on the third terminal and configured to guide led-out of the wire.

6. The choke coil of claim 5, wherein the guide part is provided under the flange.

7. The choke coil of claim 6, wherein the guide part has at least a portion protruding out of the flange.

8. The choke coil of claim 2, further comprising a guide part defined by at least a protruding portion of the flange and configured to guide the wire.

9. The choke coil of claim 5, wherein the second terminal extends from the first terminal, and the third terminal extends from the second terminal.

10. The choke coil of claim 5, further comprising an opening part formed on the third terminal.

11. The choke coil of claim 10, wherein the opening part is formed in a wider width than the wire and in a shorter length than the wire.

12. The choke coil of claim 1, further comprising a weld part formed in each of end portions of the wire.

13. The choke coil of claim 12, further comprising an insulating layer provided on at least a region between the weld part and the terminal electrode.
